(19) United States
(12) Patent Application Publication
(10) Pub. No.: US 2021/0146819 A1
(43) Pub. Date: May 20, 2021

(54) SPRAYER VEHICLES, CONTROL SYSTEMS, AND METHODS OF ADJUSTING EFFECTIVE SPACING OF SPRAY NOZZLES

(71) Applicant: AGCO Corporation, Duluth, GA (US)

(72) Inventors: Jeffrey Michael Zimmerman, Lake Park, IA (US); Mark Aron Crowley, Spirit Lake, IA (US)

(21) Appl. No.: 17/094,030

(22) Filed: Nov. 10, 2020

Related U.S. Application Data
(60) Provisional application No. 62/935,188, filed on Nov. 14, 2019.

(51) Int. Cl. B60P 3/30; B62D 21/02; B62D 49/00; B05B 1/20

(52) U.S. Cl. CPC B60P 3/30; B05B 1/20; B62D 49/00; B62D 21/02

(57) ABSTRACT

A sprayer vehicle includes a chassis having a longitudinal axis and supported by a plurality of wheels, a boom carried by the chassis, and a pivoting mechanism. The boom has a first boom extension and a second boom extension, each carrying a plurality of nozzles configured to discharge material. The pivoting mechanism is configured to co-linearly orient the first boom extension at an acute angle relative to the longitudinal axis of the chassis and the second boom extension at an obtuse angle relative to the longitudinal axis of the chassis. Other sprayer vehicles are configured to discharge material while the wheels of the sprayer are oriented at an acute angle relative to a longitudinal axis of the chassis. Control systems and methods are also disclosed.

### CROSS-REFERENCE TO RELATED APPLICATION

This application claims the benefit of the filing date of U. S. Provisional Patent Application 62/935,188, “Method for Changing Effective Sprayer Nozzle Spacing,” filed Nov. 14, 2019, the entire disclosure of which is incorporated herein by reference.

### FIELD

Embodiments of the present disclosure relate generally to crop protection, and in particular, to systems and methods for changing the effective spacing of sprayer nozzles.

### BACKGROUND

Typical liquid system booms in the United States have nozzle spacing of 20, 15, and 10 inches (and, for instance, 25 and 50 centimeters in Europe). These booms are selected based on cost, row spacing of crop, desired application rate, and other factors. Once a machine is purchased, changing the row spacing requires changing all or most of the boom plumbing, which is a large task. Some spray operations are improved if the nozzles match up with the crop rows, while others are improved by narrow spacing for higher flow rates. As an illustrative example, assume a farmer has 20-inch row corn and wants to spray both broadcast and in-season nitrogen applications. For the broadcast application, 15-inch nozzle spacing gives an advantage in coverage with low boom heights compared to 20-inch spacing. But the farmer wants the nozzles of his sprayer to match up with the rows of his corn so he can band nitrogen in season. The farmer is limited to one choice when purchasing a sprayer, resulting in a compromise to one operation or the other.

### BRIEF SUMMARY

In some embodiments, a sprayer vehicle includes a chassis having a longitudinal axis and supported by a plurality of wheels, a boom carried by the chassis, and a pivoting mechanism. The boom has a first boom extension and a second boom extension, each carrying a plurality of nozzles configured to discharge material. The pivoting mechanism is configured to co-linearly orient the first boom extension at an acute angle relative to the longitudinal axis of the chassis and the second boom extension at an obtuse angle relative to the longitudinal axis of the chassis.

In other embodiments, a control system is disclosed for a sprayer vehicle having a plurality of wheels supporting a chassis, the chassis carrying a boom carrying a plurality of nozzles configured to discharge material along a path parallel to a travel path of the chassis. The control system includes a steering system configured to orient each of the wheels of the sprayer at an acute angle relative to a longitudinal axis of the chassis, and a plurality of actuators. Each actuator is configured to enable control of material through a respective nozzle. The control system is configured to control the acute angle of the wheels relative to the longitudinal axis to yield a preselected spacing between adjacent paths formed by material discharged from the nozzles.

A method of adjusting effective spacing of a plurality of spray nozzles carried by a boom of a vehicle includes navigating the vehicle in a forward direction of travel, dispensing a material through the plurality of spray nozzles along a plurality of paths, and orienting the boom at an acute angle relative to the forward direction such that a minimum distance between adjacent paths is less than a distance between corresponding spray nozzles along the boom

### BRIEF DESCRIPTION OF THE DRAWINGS

FIG. 1 is a schematic diagram that illustrates in rear perspective view an example boom used in an embodiment of a sprayer nozzle spacing system.

FIGS. 2A-2D are schematic diagrams that illustrate in overhead plan view various arrangements of a boom oriented at different angles relative to a direction of travel of a sprayer vehicle using a pivoting mechanism at a rear location of the sprayer vehicle to enable variable effective spacing among nozzles located on a boom.

FIGS. 3A-3B are schematic diagrams that illustrate in fragmentary, overhead plan view, various arrangements of a boom oriented at different angles relative to a direction of travel of a vehicle using a crab-steer mechanism to enable variable effective spacing among nozzles located on a boom.

FIG. 4 is a schematic diagram that illustrates, in overhead plan view, one embodiment of an example pivoting mechanism using a single actuator.

FIG. 5 is a schematic diagram that illustrates, in overhead plan view, one embodiment of an example pivoting mechanism using plural actuators.

FIGS. 6A-6C are schematic diagrams that illustrate, in fragmentary, overhead plan and perspective views, another embodiment of an example pivoting mechanism using plural interior actuators.

FIGS. 7A-7B are schematic diagrams that illustrate, in overhead plan and perspective views, an embodiment of an example crab-steer mechanism.

FIG. 8 is a schematic diagram that illustrates, in fragmentary perspective view, another example crab-steer mechanism.

FIG. 9 is a schematic diagram that illustrates an embodiment of an example control system for providing steering and boom control for effecting nozzle spacing.

FIG. 10 is a flow diagram that illustrates an embodiment of an example method for dynamically adjusting the spacing at which material is discharged from nozzles on a boom.

### DETAILED DESCRIPTION

The illustrations presented herein are not actual views of any particular sprayer, but are merely idealized representations that are employed to describe example embodiments of the present disclosure. Additionally, elements common between figures may retain the same numerical designation.

Certain embodiments of a sprayer nozzle spacing system and method (collectively, sprayer nozzle spacing system) are disclosed that are implemented on a self-propelled or towed sprayer vehicle to change an effective boom width and nozzle spacing of the boom. In one embodiment, the sprayer nozzle spacing system implements this working configuration by adjusting an angle of the boom with respect to a direction of travel. In one embodiment, the entire boom pivots about a joint at a back (or front, in some embodiments) of the sprayer vehicle. In some embodiments, a three (3), four (4) or more wheel steering system may be implemented to use a crab-steer configuration, in which the entire sprayer vehicle changes angle with respect to the direction of travel.

Digressing briefly, and as mentioned above, booms are made and sold in different nozzle spacing configurations, resulting in less than optimal performance for some farming applications. Further, changing the nozzle spacing incurs significant changes to the sprayer vehicle (e.g., plumbing, software, etc.), which may result in excessive costs to the farmer and/or equipment owner. In contrast, certain embodiments of a sprayer nozzle spacing system, using either a pivoting mechanism for the boom or a crab-steer mechanism, enables a sprayer vehicle to be configured with any one of a variety of effective nozzle spacings, avoiding or mitigating the compromise on some farming applications (i.e., applying material at less-preferred nozzle spacing), which in some instances, may provide a low cost alternative to a farmer/equipment owner when compared to conventional approaches to nozzle space changes (i.e., purchasing sprayers with two different nozzle spacings).

Having summarized certain features of a sprayer nozzle spacing system of the present disclosure, reference will now be made to certain embodiments of a sprayer nozzle spacing system as illustrated in the drawings. While the sprayer nozzle spacing system will be described in connection with these drawings, there is no intent to limit it to the embodiment or embodiments disclosed herein. For instance, though emphasis is on self-propelled sprayers, some embodiments of a sprayer nozzle spacing system may be implemented in towed sprayer implements. Additionally, the pivoting mechanisms are shown located on the rear of the sprayer vehicle, though in some embodiments, front-end sprayer attachments may be used. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications, and equivalents as defined by the appended claims. The claims are not necessarily limited to the particular embodiments set out in the description.

References to certain directions, such as, for example, “front,” “rear,” “left,” and “right,” are made as viewed from the rear of the sprayer vehicle looking forwardly. The terms fore and aft and transverse or lateral, as used herein, are referenced to the longitudinal centerline of the sprayer vehicle chassis as the sprayer vehicle travels in a forward direction. The use of the term, effective, in reference to the nozzle spacing refers to the fact that the physical location of the nozzles on the boom may remain unchanged, yet the minimum distance of material discharge deposit paths (e.g., on the soil, on vegetation, etc.) between nozzles (or similarly (e.g., alternate nozzles)) changes as the angle of the boom changes relative to the direction of sprayer vehicle travel.

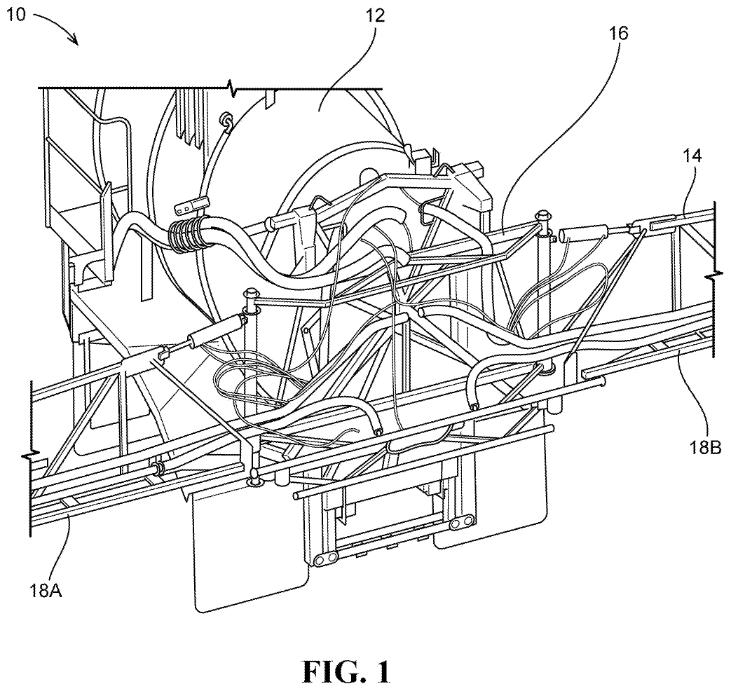

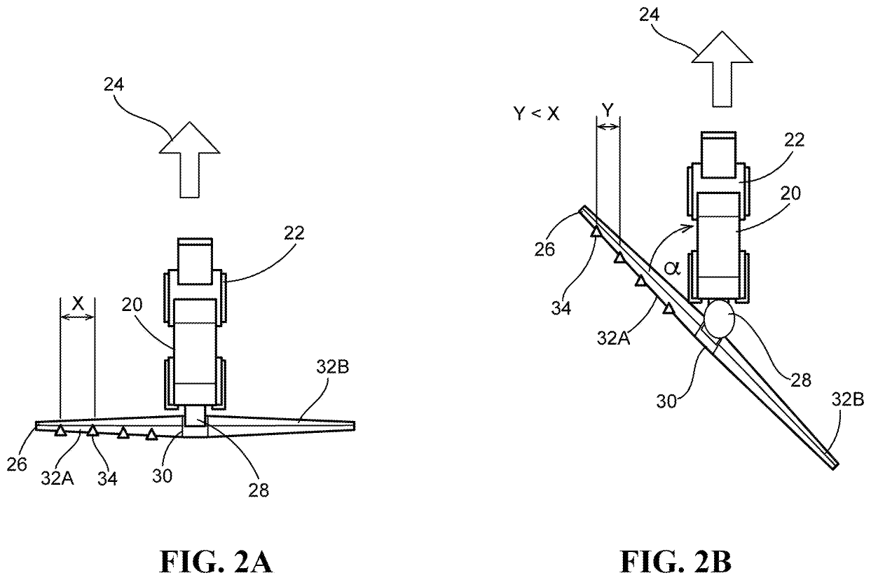

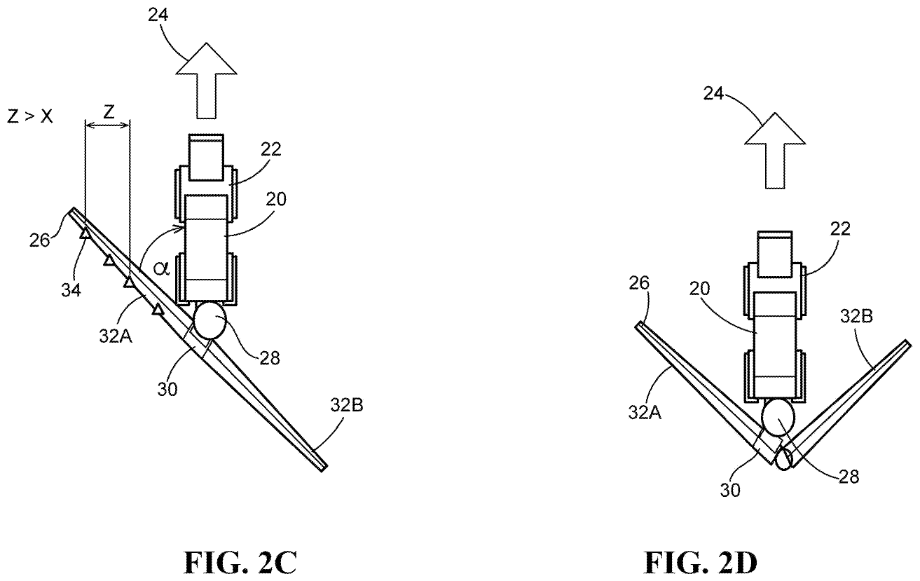

FIG. 1 is a schematic diagram that illustrates, in rear perspective view, an example boom used in an embodiment of a sprayer nozzle spacing system. In particular, shown is a rear portion of a self-propelled, agricultural sprayer vehicle 10 comprising a chassis that supports a tank 12 (or other type of storage compartment) and a foldable boom 14. The sprayer vehicle 10 may be any one of a plurality of different manufacturer types for the agricultural industry or other industries, including a Terragator® or Rogator® from AGCO Corporation, of Duluth, Ga., among others. The tank 12 may store liquid material, including pesticides, herbicides, insecticides, fungicides, fertilizer, etc. The boom 14 may have multiple portions, including a height-adjustable, central boom tree 16, and foldable boom extensions 18A and 18B. In one embodiment, the boom tree 16 serves as the location for a pivoting mechanism that enables adjustments in effective nozzle spacing through boom rotation, as described below. The foldable boom extensions 18 may be extended laterally (e.g., orthogonally to the direction of travel of the sprayer vehicle 10) as well as separately or jointly folded forwardly up to a road transport configuration (e.g., where the boom extensions 18 are adjacent and proximal to the sides of the sprayer vehicle 10). The boom 14 comprises plural, evenly-spaced nozzles 34 (shown in FIG. 2A) that are used to discharge material from the tank 12 onto plants or other vegetation and/or the soil. In one embodiment, each nozzle 34 is controlled by a respective actuator (e.g., solenoid) to enable on/off operation and/or fluid flow variation. The boom 14 also includes subsystems for enabling material flow to and from the tank 12, such as hydraulic and/or hydronic components (e.g., pumps, valves, etc.), fluid carrying components (e.g., hoses), and control and/or power cabling for various devices on the boom 14 (e.g., sensors, actuators, etc.).

Though depicted and described as an agricultural sprayer vehicle 10, some embodiments may include sprayer vehicles in other industries, including for municipalities and/or commercial/industrial applications (e.g., construction, mining, etc.). Further, though the boom 14 is depicted on the chassis of a self-propelled sprayer vehicle 10, in some embodiments, the boom 14 may be part of a towed implement. In some embodiments, the boom 14 may be located at the front of the sprayer vehicle 10.

FIGS. 2A-2D are schematic diagrams that illustrate in overhead plan view of various arrangements of a boom oriented at different angles relative to a direction of travel of a sprayer vehicle using a pivoting mechanism at a rear location of the sprayer vehicle to enable variable effective spacing among nozzles carried by the boom. In particular, FIGS. 2A-2D show a sprayer vehicle 20 having a chassis supported from the ground by wheels 22 (e.g., four (4) wheels, though not limited to four), and represented as moving in a forward direction 24. At the rear of the sprayer vehicle 20 is a foldable boom 26 and a pivoting mechanism that includes a joint 28 (exaggerated in size for purposes of illustration), about which the boom 26 controllably rotates to any one of a plurality of selected angles relative to the forward direction 24 of travel of the sprayer vehicle 20. The boom 26 has a central boom tree 30 and boom extensions 32A, 32B. The boom extensions 32A, 32B carry nozzles that are, in one embodiment, evenly spaced along the length of the boom extensions 32. In FIGS. 2A-2C, nozzles 34 (e.g., four (4)) are shown distributed along only boom extension 32A for ease of description and illustration, and represented as triangle symbols. It should be appreciated by one having ordinary skill in the art that there may be a different quantity of nozzles, and that both boom extensions 32A, 32B would normally carry nozzles 34 (as would be understood for all figures in this disclosure). Note that in some embodiments, the sprayer vehicle 20, foldable boom 26, boom tree 30, and boom extensions 32 may have a similar structural arrangement and/or function to that of sprayer vehicle 10, boom 14, boom tree 16, and boom extensions 18 of FIG. 1.

Referring specifically to FIG. 2A, the boom 26 is shown with boom extensions 32 extending outward from the sprayer vehicle 20 and each oriented orthogonal to the direction 24 of vehicle travel. That is, the pivoting mechanism is adjusted to enable the nozzles 34 to discharge material at an effective spacing defined by X in FIG. 2A, which corresponds to the distance between the nozzles 34 themselves (e.g., center-to-center).

In FIG. 2B, the boom 26 is shown oriented at an acute angle a relative to the direction 24 of vehicle travel. The pivoting mechanism causes rotation of the boom 26 about the joint 28 to enable the nozzles 34 to discharge material along paths separated by a distance Y, which corresponds to an effective spacing Y, where effective spacing Y is less than spacing X (FIG. 2A). The boom extensions 32A, 32B are co-linearly oriented (e.g., not folded). Thus, the first boom 32A is oriented at the acute angle a relative to the direction 24 of vehicle travel (which in this embodiment is parallel to or along the longitudinal axis of the chassis of the sprayer vehicle 20), and the second boom 32B is oriented at an obtuse angle 180°-α relative to the direction 24 of vehicle travel. That is, the angle of the first boom 32A relative the direction 24 and the angle of the second boom 32B relative to the direction 24 are supplementary angles (i.e., the angles total) 180°. In certain embodiments, the pivoting mechanism can be adjusted to cause an angle of the boom 26 to be changed relative to the direction 24 of vehicle travel, to enable variable nozzle spacing, with virtually any effective nozzle spacing within the mechanical limits of the pivoting mechanism. Effective nozzle spacing including, and less than, the standard nozzle spacing are achievable using the same boom 26, without plumbing changes to the boom 26, by adjustment of the boom angle α. For instance, not only effective nozzle spacing of 20 inches and 15 inches are possible, but also non-standard effective spacing, including 14.562 inches, 19.46 inches, etc.

FIG. 2C illustrates how the effective nozzle spacing may be increased beyond the actual nozzle spacing on the boom 26 by selectively deactivating a subset of the nozzles 34. As shown, alternating nozzles 34 may be selectively deactivated, such that only about half the nozzles discharge material. The active nozzles 34 discharge material along paths separated by a distance Z, which corresponds to an effective spacing Z, where effective spacing Z is greater than spacing X (FIG. 2A). Note that the effective spacing Z is twice the effective spacing Y shown in FIG. 2B. Though FIG. 2C depicts deactivating alternating nozzles, larger spacing may be achieved by deactivating more nozzles (e.g., activating only every third nozzle, every fourth nozzle, etc.). Thus, by rotating the boom and optionally deactivating some nozzles, virtually any effective nozzle spacing may be selected, not merely the actual nozzle spacing along the boom.

FIG. 2D shows an example in which variations in effective nozzle spacing may be achieved through folding of one or both of the boom extensions along any one of a continuum of different angles (e.g., where boom extension 32A, 32B are not co-linearly arranged).

Pivoting the boom extensions 32 relative to the sprayer vehicle 20 and the direction 24 of vehicle travel also changes the effective width of the boom 26. That is, the maximum width of the vehicle 20, including the boom 26, when the boom 26 is in the orientation shown in FIG. 2B is less than the length of the boom 26 itself (which corresponds to the maximum width of the vehicle 20 in the orientation shown in FIG. 2A). Therefore, if the boom 26 can rotate relative to the direction 24 of vehicle travel, the sprayer vehicle 20 may operate in situations with smaller side-to-side clearance.

Though the pivoting mechanism (including the joint 28) is shown and described at the rear of the sprayer vehicle 20, in some embodiments, the pivoting mechanism (and boom 26) may be located at the front of the sprayer vehicle 20. Further, though a chassis with a four-wheel configuration is depicted in FIGS. 2A-2D, in some embodiments, chassis with other wheel arrangements may be used (e.g., three wheels, more than four wheels).

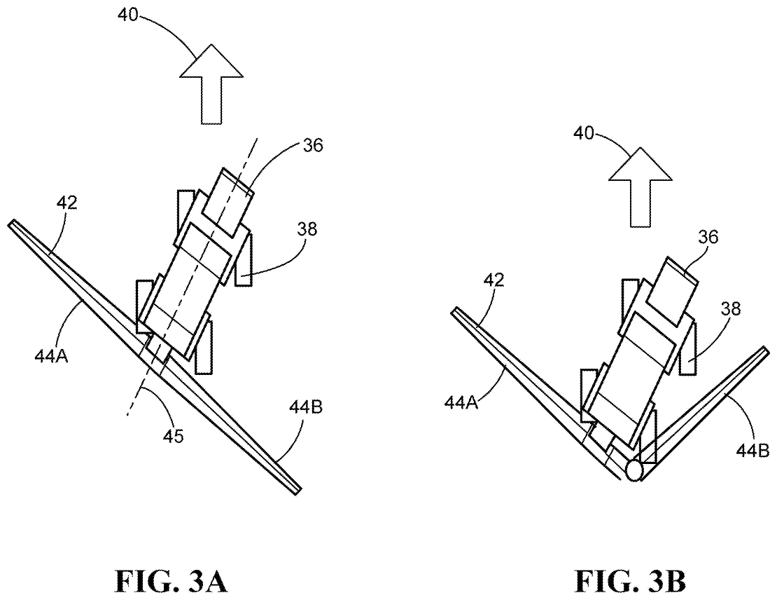

Having shown examples in which the boom 26 may be oriented at an angle relative to the direction of vehicle travel via rotation about a joint 28 to enable the discharge of material from nozzles at variable spacing, attention is now directed to FIGS. 3A-3B, which illustrate another mechanism to achieve the variable spacing. In particular, FIGS. 3A-3B show a sprayer vehicle 36 that comprises steering controls and components that configure wheels 38 (e.g., four wheels in this example, though other wheel quantities are possible) into a crab-steer configuration. The sprayer vehicle 36 is represented as moving in the forward direction 40, which is angled relative to a longitudinal axis 45 of the sprayer vehicle 36. The sprayer vehicle 36 has a foldable boom 42 having boom extensions 44A, 44B. The sprayer vehicle 36 and boom 42 may be of a similar type and structure as sprayer vehicle 10 and boom 14 shown in FIG. 1. The wheels 38 are shown arranged in a crab-steer configuration, and the sprayer vehicle 36 is oriented at an angle relative to the forward direction 40 of travel while the wheels 38 are oriented in the forward direction 40. In other words, steering controls cause the wheels 38 to be oriented in the fore-and-aft direction yet at respective angles to the longitudinal axis 45 of the sprayer vehicle 36. By implementing the crab-steer configuration, the boom 42 may remain oriented directly outward from the sprayer vehicle 36 (e.g., orthogonal to the longitudinal axis 45 of the sprayer vehicle 36) and/or folded in similar manner to that described above in association with FIG. 2C, which in turn enables a decrease in effective nozzle spacing (nozzles are omitted from FIGS. 3A-3B for clarity). In FIG. 3A, the boom orientation relative to the direction of travel may result in a similar change in effective nozzle spacing as that shown in, and described in association with, FIG. 2B. In the depicted configuration of FIG. 3A, boom extensions 44A, 44B are co-linearly aligned, and at an acute angle relative to the forward direction 40. FIG. 3B illustrates a boom configuration in which the boom extension 44B is angled forward relative to the boom extension 44A. Through the crab-steer configuration, as in the pivoting mechanism embodiment shown in FIGS. 2A-2C, effective nozzle spacing may be variably adjusted without overhauling the plumbing and other components of the sprayer vehicle 36.

Note that in some embodiments, the boom 42 may be located in the front of the sprayer vehicle 36. In some embodiments, the various mechanisms for changing the effective spacing disclosed herein may be combined. For instance, in some embodiments, the pivoting mechanism of the sprayer vehicle 20 of FIGS. 2A-2C may be used in conjunction with the crab-steer arrangement shown in FIGS. 3A-3B. In some embodiments, additional spacing adjustments may be made through the select activation/deactivation of nozzles (e.g., material discharged through alternate nozzles among a series of nozzles along the boom 42), as discussed above with reference to FIG. 2C.

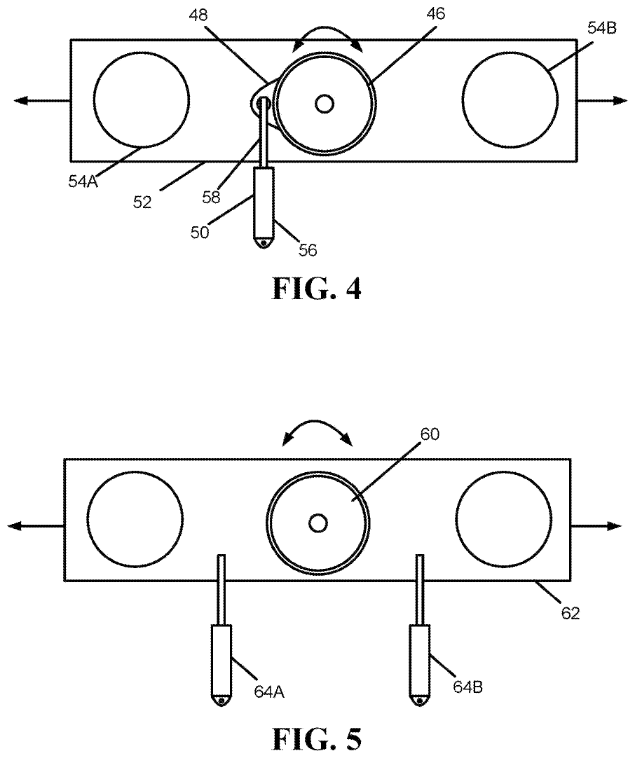

FIGS. 4-6C show various embodiments for implementing the pivoting mechanisms that may be used with the sprayer vehicle 20 shown in FIGS. 2A-2D. For instance, FIG. 4 is a schematic diagram that illustrates in overhead plan view one embodiment of an example pivoting mechanism using a single actuator 50. The pivoting mechanism includes a joint 46 that is surrounded by a collar 48 that is secured to the frame of the boom. The actuator 50 is coupled to the collar 48. The joint 46 is disposed centrally to a boom tree 52, which includes telescoping posts 54 (e.g., 54A, 54B) on opposite sides of the joint 46 and that enable the boom tree 52 to be adjusted in height (raising and lowering the boom). Though shown as cylindrical posts, posts of other geometric configurations (e.g., square, rectangular, etc.) may be used. The actuator 50 may include a hydraulic cylinder, pneumatic cylinder, or electrical cylinder (among other types) having in one embodiment a body 56 and retractable piston rod 58, which when activated (e.g., via an upstream hydraulic valve in the case of a hydraulic actuator, enabling the controlled flow of hydraulic fluid through the actuator 50), extends or retracts the piston rod 58. Through the operative coupling of the piston rod 58 and the collar 48 (e.g., using a bolt assembly or other known securement components at the connection between a flange portion of the collar 48 and the piston rod 58), boom rotation (the boom extensions omitted and represented by outward arrow symbols on opposing sides of the boom tree 52) about the joint 46 is controlled via the extension and retraction of the piston rod 58. Though depicted using a single actuator 50, in some embodiments, additional actuators may be used. For instance, the collar 48 may include two laterally opposing flanges for connection with two piston rods of two actuators (e.g., one actuator coupled to one flange of the collar, the other actuator coupled to the other flange), and rotation may be coordinated between the two actuators or performed in a mutually exclusive manner through a respective defined range of rotation. Note that though a piston-rod type actuator is described throughout the present disclosure as a type of actuator for illustrative purposes, other types of actuators may be used (e.g., rotary actuators, among others known in the art). Further, though a joint and actuator(s) are described as the pivoting mechanism in FIGS. 4-6C to enable rotation of the boom, in some embodiments, a gear assembly, belt drive, or other mechanisms for causing rotation of the boom may be used as a pivoting mechanism.

FIG. 5 illustrates another example pivoting mechanism using plural actuators. For instance, a joint 60 resides centrally to a tree tower 62. The joint 60, like the joint 46 in FIG. 4, enables rotation of the boom tree 62 (and hence rotation of the coupled boom extensions). Actuators 64 (64A, 64B) are secured (e.g., bolted) to the frame of the boom tree 62 on laterally opposing sides of the joint 60, where activation of the actuators 64 may be coordinated or selectively enabled in mutually exclusive fashion over a respective rotational range. The actuators 64 may be of a similar type as actuator 50 described above in association with FIG. 4.

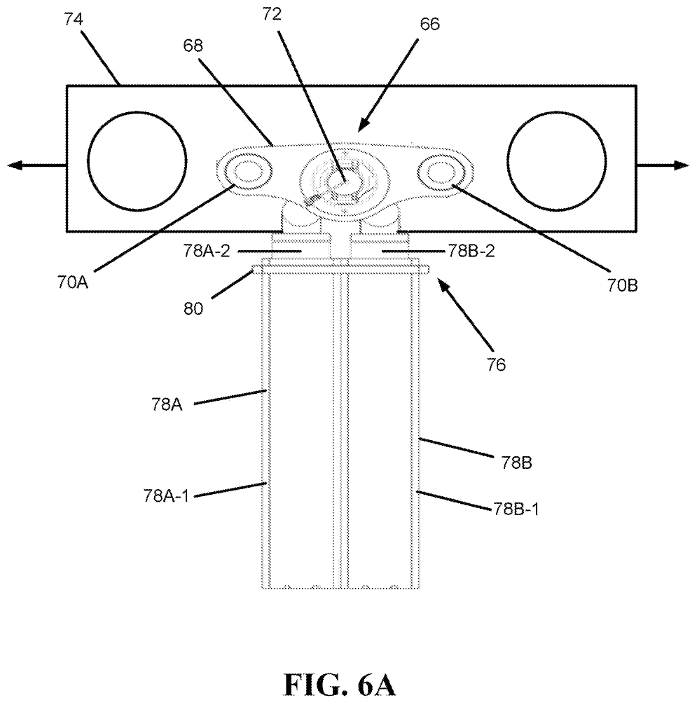

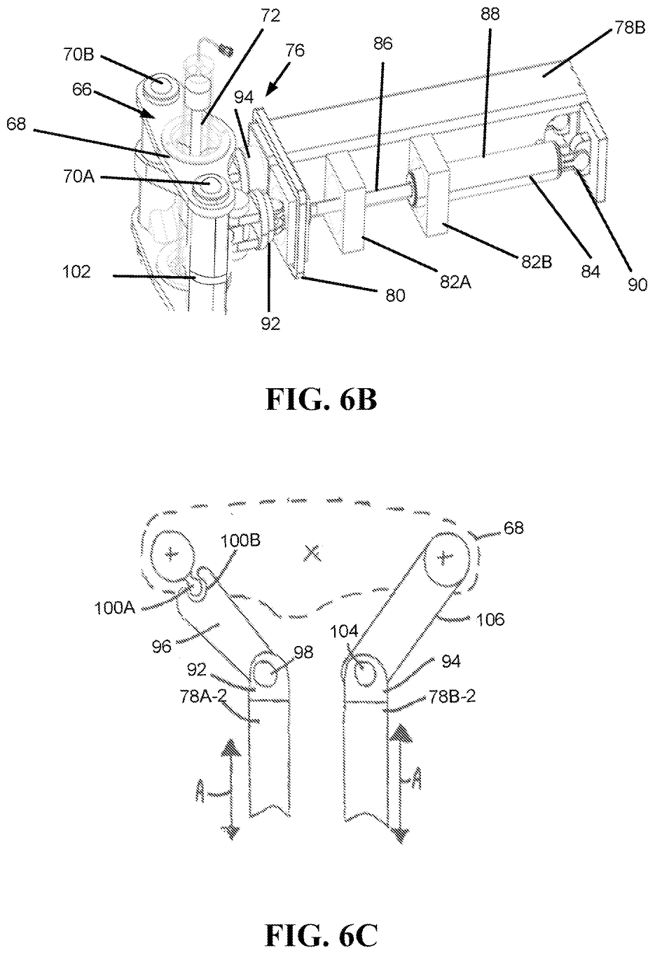

FIGS. 6A-6C illustrate yet another example pivoting mechanism using interior actuators. A pivoting mechanism 66 enables rotation of the boom and includes a bracket assembly 68. The bracket assembly 68 has two posts 70A, 70B secured to a boom tree 74, and a central joint 72 that enables rotation of the bracket assembly 68 under the controlled influence of actuators coupled to the posts 70A, 70B. The joint 72 is centrally located in the boom tree 70. The bracket assembly 68 is coupled to outboard ends 76 of first and second telescopic assemblies 78A, 78B. Each telescopic assembly 78A, 78B is elongate and extends from the rear of the chassis of the sprayer vehicle to which the boom is attached. The telescopic assemblies 78A, 78B are laterally spaced from one another and, in one embodiment, aligned parallel to one another in a side-by-side relationship. Both telescopic assemblies 78A, 78B are secured to the chassis by suitable attachment mechanisms (e.g., welding, bolted, etc.), which provide a rigid and fixed structural relationship. The telescopic assemblies 78A, 78B may also be secured to one another at a distance from the chassis to provide suitable rigidity. As shown in FIGS. 6A and 6B, an end plate 80 may be secured between both telescopic assemblies 78A, 78B to provide rigidity.

Each of the telescopic assemblies 78A, 78B includes a respective outer portion 78A-1, 78B-1 and a respective inner portion 78A-2, 78B-2. Each inner portion 78A-2, 78B-2 is slidingly received by the associated outer portion 78A-1, 78B-1 in a telescoping manner. The sliding relationship is along the longitudinal axis of the assemblies 78A, 78B and enables extension and retraction of the inner assemblies 78A-2, 78B-2 which, in turn, enables the rotation of the bracket assembly 68 and hence the boom tree 74 (and boom). Each outer portion 78A-1, 78B-1 includes a tubular member (e.g., of square cross section) secured to the chassis. Bearing blocks 82 (e.g., 82A, 82B, though not limited to two) may be disposed inside the tubular members. The inner portions 78A-2, 78B-2 are slidingly received in the respective sets of bearing blocks 82 to allow for telescoping extension and retraction with respect to the outer portions 78A-1, 78B-1. Each of the inner portions 78A-2, 78B-2 may be part of a hydraulic actuator 84 (one shown, the other obscured from view in telescopic assembly 78B of FIG. 6B). The hydraulic actuators 84 may also include a piston rod 86 slidingly received in a cylindrical housing 88 that forms the inner portion 78A-2. The cylinder housing 88 and piston rod 86 that form the inner portion 78A-2 are slidingly received and supported by the bearing blocks 82. The piston rod 86 extends and retracts from the cylinder housing 88 in a fore-and-aft manner in the direction of the chassis. The cylinder housing 88 is coupled indirectly to the chassis via outer portion 78A-1 by a pin connection 90. Alternatively, the cylinder housing 88 may be coupled directly to the chassis. Extension and retraction of hydraulic actuators 84 (from both assemblies 78A and 78B) causes the inner portions 78A-2,78B-2 to telescope out of and in to the outer portions 78A-1,78B-1 as the piston rods 86 exert a force upon the posts 70A, 70B of the bracket assembly 68.

Referring to FIGS. 6B-6C, the outboard end 76 of each of inner portions 78A-2, 78B-2 may include a respective clevis 92, 94 secured to the end of the piston rods 86 or integrated therewith. The bracket assembly 68 is coupled to the devises 92, 94. Clevis 92 on the outboard end 76 of the inner portion 78A-2 is coupled to the bracket assembly 68 via a link arm 96. The link arm 96 is pivotally connected to the telescopic assembly 78A by a first pivotable connection 98 provided by a pin inserted through the clevis 92. The link arm 96 can thus pivot with respect to the inner portion 78A-2 around pin 98. The link arm 96 is connected at a second end to the bracket assembly 68 by a ball-and-socket joint 100. The joint 100 includes a ball 100A which is integral with a collar 102 (FIG. 6B) that is fixed to the post 70A. The joint 100 also includes a socket 100B which is integrally formed in the second (outboard) end of link arm 96. The first pivotable connection 98 and the ball-and-socket joint 100 provide a dual-axis hinge connection between the assembly 78A and the bracket assembly 68. In an alternative embodiment, the ball joint 100 is replaced with a pin joint. The clevis 94 on the outboard end of the telescopic assembly 78B is coupled to the bracket assembly 68 by a second pivotable connection 104 by a pin inserted through the clevis 94. A crank arm 106 is rigidly connected to the bracket assembly 68 and serves as an attachment point for the telescopic assembly 78B. The pin provides the pivotable connection 104 and couples the crank arm 106 to the clevis 94. The bracket assembly 68 is, therefore, coupled to outboard ends of the telescopic assemblies 78A, 78B by pivotable connections 98 and 104. Extension and retraction of telescopic assemblies 78A, 78B is used to control the rotation of the bracket assembly 68, and hence the rotation of the boom about the joint 72 (shown with an “x” in FIG. 6C). With reference to FIG. 6C, arrow symbols denoted ‘A’ illustrate the direction of extension and retraction. FIGS. 6A-6C and the description above are illustrative of one pivoting mechanism, and it should be appreciated that variations to the above and/or other mechanisms for causing rotation of the boom may be used.

Control for the pivoting mechanism 66 of FIGS. 6A-6C may include one or more controllers that are electrically connected to actuators (e.g., solenoids) of two directional control valves that each serve to control the delivery of pressurized hydraulic fluid to the actuators 84 of the telescopic assemblies 78A, 78B. For the control of pivoting mechanisms described in association with FIGS. 4-5, similarly, one or more controllers may signal an actuator(s) of one or more directional valves to control pressurized fluid in turn to the actuators of the pivoting mechanisms. In some embodiments, other mechanisms of control may be used, including actuation based on electrical, pneumatic, or magnetic forces, with or without directional valves. In some embodiments, different structures and/or arrangements may be implemented to enable rotation of the boom.

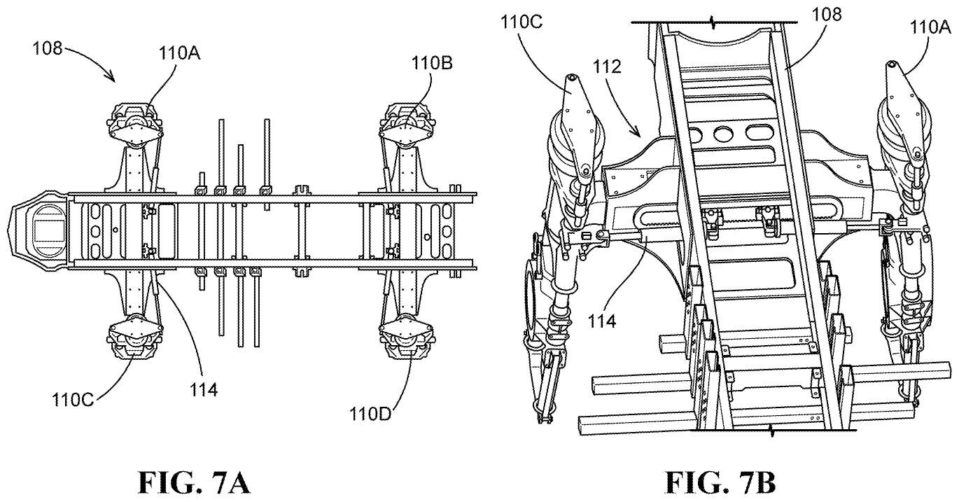

FIGS. 7A-9 illustrate various embodiments of a crab-steer mechanism for a sprayer nozzle spacing system. FIG. 7A, shows a fragmentary, overhead plan view of a chassis 108 for a sprayer vehicle (e.g., sprayer vehicle 36 disclosed herein). Located at each axle is a pair of mounting assemblies, including mounting assemblies 110A, 110B, 110C, and 110D. FIG. 7B provides a closer view of a portion of the chassis 108 and mounting assemblies 110A and 110C. In the depicted embodiment, and focusing on the left-hand side mounting assembly 110C (with similar applicability to the right hand side mounting assembly 110A and other mounting assemblies 110B, 110D), two actuators are used to perform track and steering functionality, respectively. One interior actuator, hidden from view yet running within axle assembly 112, is coupled to the mounting assembly 110C to perform tracking functionality. A similar actuation arrangement has been described for the telescopic assemblies 78 described in association with FIGS. 6A-6B. Another actuator includes an external steering cylinder 114, which is coupled between the axle assembly 112 and the mounting assembly 110A. Selective and coordinated extension and retraction of the actuators cause rotation of the mounting assembly 110C. Logic in a controller(s) coordinates directional valves (e.g., via activation at respective solenoids to enable control of hydraulic fluid flow) to influence the control of the external and interior tracking cylinders to enable the crab-steering functionality. Note that the structure and arrangement of the mounting assemblies 110 are for illustration, and that other known mounting assembly arrangements may be used to enable rotation of each wheel according to a crab-steer configuration.

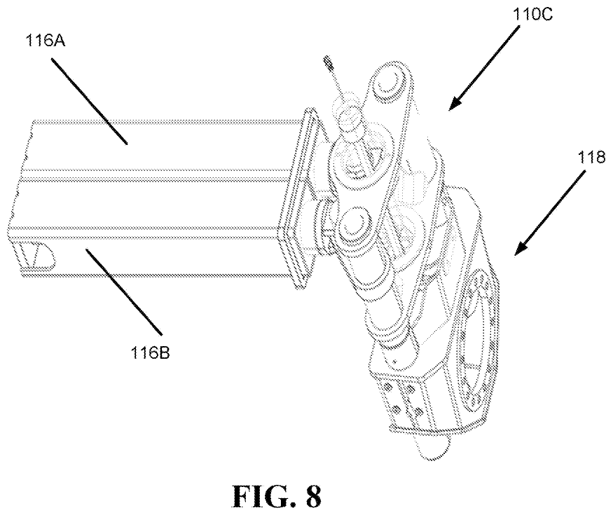

Another embodiment is shown in FIG. 8, which replaces the external steering cylinder 114 of FIGS. 7A-7B with an interior steering cylinder. In other words, telescopic assemblies 116A, 116B, similar to those (e.g., 78A, 78B) described in association with FIGS. 6A-6C, are used to control the steering and tracking functionality of the mounting assembly 110. Similarly, all mounting assemblies 110 are controlled in the same manner by their respective telescopic assemblies. Note that the mounting assembly 110C, unlike the structure depicted in FIGS. 6A-6B, comprises a hub portion 118 that receives a drive motor (e.g., hydraulic drive motor) that is drivingly connected to a wheel. The drive motor may be hydraulic, pneumatic, or electric, and derives its power from a prime mover located on the chassis 108. The motor rotates to provide forward and reverse propulsion to the wheels in known manner. As described above, software and/or firmware in cooperation with steering controls coordinate the rotation of the wheels via the depicted assembly in FIG. 8 (and FIGS. 7A-7B) to enable the crab-steer configuration to be implemented.

Additional steering mechanisms that may be used to enable the crab-steer mechanism are described in U.S. Pat. No. 9,296,273, “Machine Suspension and Height Adjustment,” granted Mar. 29, 2016; and U.S. Patent Publication 2019/0315395, “Four-Wheel Steering with Front/Rear Matching Geometries,” published Oct. 17, 2019, the entire disclosures of each of which are hereby incorporated by reference herein.

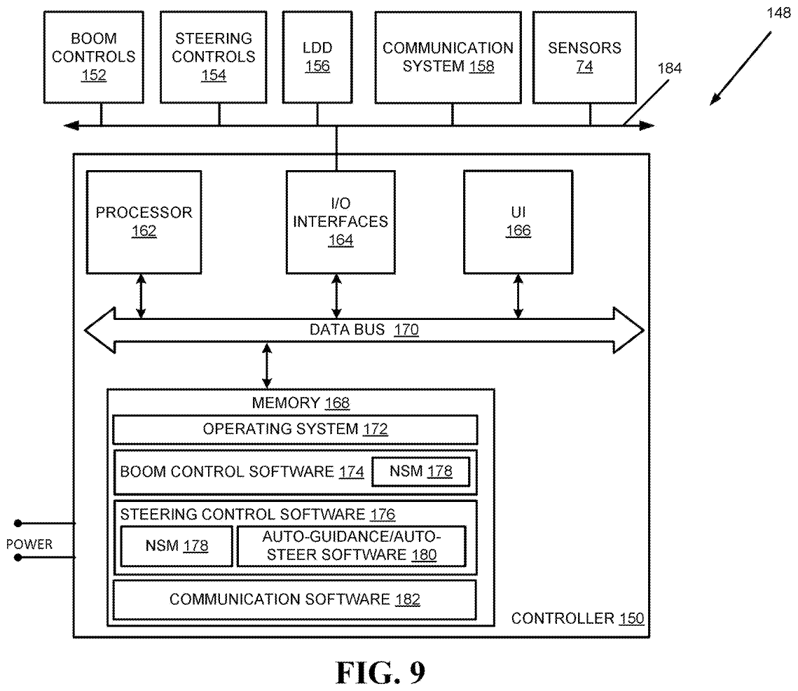

FIG. 9 illustrates an embodiment of an example control system 148 that may be used in an embodiment of a sprayer nozzle spacing system. The control system 148 depicted in FIG. 9 is one illustration for achieving control of the pivoting mechanism and/or crab-steer configurations, and in some embodiments, a different number of components, or a different control arrangement, may be used to implement the functionality described above for the various embodiments of a sprayer nozzle spacing system. In the depicted embodiment, the control system 148 includes one or more controllers 150 (one shown), and various controls including boom controls 152, steering controls 154, as well as other components including location determining device(s) (LDD) 156 (e.g., Global Navigation Satellite System (GNSS), including Global Positioning System (GPS), inertial components, among others), communication system 158 (e.g., cellular modem, wireless modem), and sensors 160 (e.g., environmental sensors, etc.). In some embodiments, location may be determined using cellular mechanisms (e.g., triangulation). Though illustrated using a single controller 150, in some embodiments, a sprayer nozzle spacing system may be controlled by controllers operating under distributed or centralized control (e.g., peer-to-peer, master-slave, etc.). In the context of the present disclosure, the example controller 150 is merely illustrative, and some embodiments of the controller 150 may have fewer or additional components, and/or some of the functionality associated with the various components depicted in FIG. 9 may be combined, or further distributed among additional modules. Functionality of modules described herein may be implemented as software (including firmware, microcode), hardware, or a combination of software and hardware. In some embodiments, functionality of the controller 150 may be implemented according to any of various types of devices, including a computer, programmable logic controller (PLC), FPGA device, ASIC device, among other devices. Well-known components of computer devices are omitted here to avoid obfuscating relevant features of the controller 150.

In one embodiment, the controller 150 includes one or more processors, such as processor 162, input/output (I/O) interface(s) 164, a user interface (UI) 166, and memory 168, all coupled to one or more data busses, such as data bus 170.

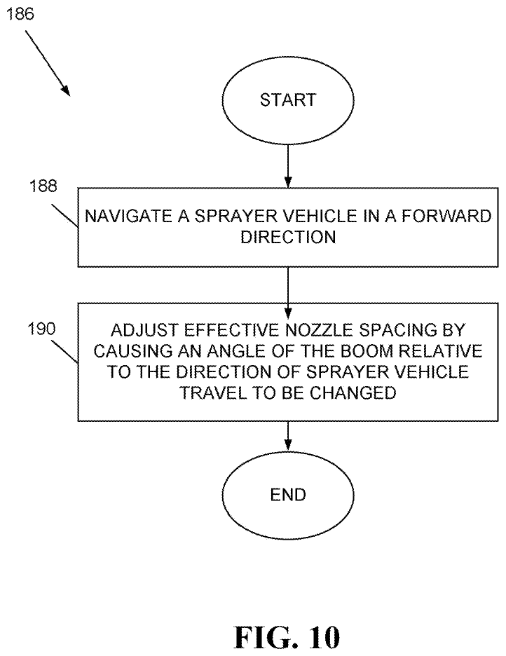

The memory 168 may include any one or a combination of volatile memory elements (e.g., random access memory (RAM, such as DRAM, SRAM, SDRAM, etc.)) and nonvolatile memory elements (e.g., ROM, Flash, solid state, EPROM, EEPROM, etc.). The memory 168 may store a native operating system, one or more native applications, emulation systems, or emulated applications for any of a variety of operating systems and/or emulated hardware platforms, emulated operating systems, etc. In the embodiment depicted in FIG. 10, the memory 168 includes an operating system 172, boom control software 174, and steering control software 176. In one embodiment, each of the boom control software 174 and steering control software 176 includes a nozzle spacing module (NSM) 178. In some embodiments, the nozzle spacing module 178 is a sub-module of only one of the boom control software 174 or the steering control software 176 (e.g., if the sprayer vehicle does not have the steering hardware needed for crab-steer, the nozzle spacing module 178 may be executable code in the boom control software 174). The memory 168 may include auto-guidance/auto-steer software 180 (e.g., a component of the steering control software 176), communications software 182, or any other software. In some embodiments, the software/firmware modules depicted in FIG. 10 may be arranged in other ways (e.g., the nozzle spacing module 176 is a separate module called upon execution by the requesting software). Additional or fewer software modules (e.g., combined functionality) may be employed in the memory 168 or additional memory. For instance, in some embodiments, memory 168 may not include auto-guidance/auto-steer software 180 and/or communications software 182. In some embodiments, a separate storage device may be coupled to the data bus 170, such as a persistent memory (e.g., optical, magnetic, and/or semiconductor memory and associated drives).

The processor 162 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 150.

The I/O interfaces 164 provide one or more interfaces to a network, which in one embodiment comprises a communication medium 184. The communication medium 184 may be a wired medium (e.g., controller area network (CAN) bus), a wireless medium (e.g., Bluetooth channel(s), near field communications (NFC), etc.), or a combination of wired and wireless media. The I/O interfaces 164 may include any number of interfaces for the input and output of signals (e.g., analog or digital data) for conveyance over the communication medium 184. In the depicted embodiment, the boom controls 152, steering controls 154, LDD 156, communication system 158, and sensors 160 are coupled to the medium 184, enabling communication of signals/data with the controller 150 via the I/O interfaces 164.

The user interface (UI) 166 may include a keyboard, mouse, microphone, touch-type display device, head-set, and/or other devices (e.g., switches) that enable input by an operator and/or provide outputs (e.g., visual and/or audible) feedback to the operator.

The manner of connections among two or more components depicted in FIG. 9 may be varied. For instance, in some embodiments, the user interface 166 may be directly connected to the medium 184, and in communication with the controller 150 via the I/O interfaces 164.

The boom controls 152 include the components that, based on instructions from the boom control software 174 and nozzle spray module 178, enable the folding of the boom, raising of the boom (via the boom tree), select and/or wholesale nozzle activation/deactivation, and/or activation and/or control of a pivoting mechanism used to enable rotation of the boom relative to the sprayer vehicle travel direction to enable variable effective spacing of nozzles. In one embodiment, the boom controls 152 include electromagnetic directional valves that regulate the flow of hydraulic fluid through hydraulic actuators used in effecting the folding of the boom, rotation of a pivoting mechanism, and raising and lowering of the boom tree. Though described using fluid motive forces (hydraulics), in some embodiments, other and/or a mix of hydraulic, pneumatic, and electrical/electromagnetic energy may serve as motive forces for the boom controls 152. The nozzles may include solenoid components that likewise are controlled through the boom control software 174. For instance, as described above, spacing between nozzles may be effectively altered through select activation/deactivation of alternate nozzles in a sequence of nozzles arranged along the boom.

The steering controls 154 include hydraulic, pneumatic, electrical, and/or electromagnetic components to implement sprayer vehicle steering, and in one embodiment, the crab-steering functionality of the sprayer vehicle. Each of the wheels may involve a mounting assembly that uses one or more directional valves and actuators to provide, in conjunction with instructions from the steering control software 176 and the nozzle spacing module 178, track and steering functionality of the mounting assemblies for the wheels in a crab-steer configuration. The wheel orientations are controlled in coordinated fashion to enable the crab-steer configuration. The steering controls 154 may also be used with auto-guidance/auto-steer software 180 in conjunction with the LDD 156 to enable autonomous or semi-autonomous navigation and steering control of the sprayer vehicle.

The LDD 156 includes GNSS functionality, including inertial components (e.g., gyroscope).

The communication system 158 operates in conjunction with the communication software 182 to enable cellular and/or wireless (e.g., wireless fidelity, 802.11, cellular, etc.) communications. Control of the sprayer vehicle may be partially or entirely via remote control (e.g., from a farm manager office, contractor, etc.). In some embodiments, field maps may be accessed from a remote server.

The sensors 160 include wheel angle sensors, ground speed sensors, machine inclination sensors, environmental sensors (e.g., wind sensors, humidity sensors, etc.), crop height sensors, among others, and in some embodiments, may make up at least part of the other controls (e.g., boom controls 152, steering controls 154, etc.).

When certain embodiments of the controller 150 are implemented at least in part with software (including firmware), as depicted in FIG. 9, the software can be stored on a variety of non-transitory computer-readable storage medium for use by, or in connection with, a variety of computer-related systems or methods. In the context of this document, a computer-readable storage medium may include an electronic, magnetic, optical, or other physical device or apparatus that may contain or store a computer program (e.g., executable code or instructions) for use by or in connection with a computer-related system or method. The software may be embedded in a variety of computer-readable storage mediums for use by, or in connection with, an instruction execution system, apparatus, or device, such as a computer-based system, processor-containing system, or other system that can fetch the instructions from the instruction execution system, apparatus, or device and execute the instructions.

The controller 150 may be powered by a battery or other source of electricity (e.g., solar, generator, etc.).

In view of the above description, it should be appreciated by one having ordinary skill in the art, in the context of the present disclosure, that a method for dynamically adjusting the spacing at which material is discharged from nozzles on a boom, depicted as method 186 in FIG. 10, and implemented by one or more processors of the control system 148, comprises navigating (either via auto-steer/auto-guidance, or manually) a sprayer vehicle in a forward direction (188), and adjusting effective nozzle spacing by causing an angle of the boom relative to the direction of sprayer vehicle travel to be changed (190).

Any process descriptions or blocks in flow diagrams should be understood as representing logic and/or steps in a process, and alternate implementations are included within the scope of the embodiments in which functions may be executed out of order from that shown or discussed, including substantially concurrently, or with additional steps (or fewer steps), depending on the functionality involved, as would be understood by those reasonably skilled in the art of the present disclosure.

While the present invention has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention as contemplated by the inventors. Further, embodiments of the disclosure have utility with different and various machine types and configurations.

What is claimed is:

1. A sprayer vehicle, comprising:
a chassis having a longitudinal axis and supported by a plurality of wheels;
a boom carried by the chassis, the boom comprising a first boom extension and a second boom extension, each boom extension carrying a plurality of nozzles configured to discharge material; and
a pivoting mechanism configured to co-linearly orient the first boom extension at an acute angle relative to the longitudinal axis of the chassis and the second boom extension at an obtuse angle relative to the longitudinal axis of the chassis.

2. The sprayer vehicle of claim 1, wherein the pivoting mechanism is configured to orient the second boom at the obtuse angle, wherein the obtuse angle is supplementary to the acute angle.

3. The sprayer vehicle of claim 1, further comprising a control system configured to selectively deactivate a subset of the nozzles on each boom extension.

4. The sprayer vehicle of claim 1, wherein the pivoting mechanism comprises a joint and at least one actuator, wherein the boom is configured to rotate about the joint based on activation of the at least one actuator.

5. The sprayer vehicle of claim 1, wherein the boom is located at a rear of the chassis.

6. The sprayer vehicle of claim 1, wherein the boom is located at a front of the chassis.

7. The sprayer vehicle of claim 1, wherein the sprayer vehicle comprises a self-propelled vehicle.

8. The sprayer vehicle of claim 1, wherein the sprayer vehicle comprises a towed sprayer implement configured to be operated while towed behind a self-propelled tractor.

9. The sprayer vehicle of claim 8, further comprising a communication system configured to enable a control system of the self-propelled tractor to control the pivoting mechanism.

10. A control system for a sprayer vehicle comprising a plurality of wheels supporting a chassis, the chassis carrying a boom carrying a plurality of nozzles configured to discharge material along a path parallel to a travel path of the chassis, the control system comprising:
a steering system configured to orient each of the wheels of the sprayer at an acute angle relative to a longitudinal axis of the chassis; and
a plurality of actuators, each actuator configured to enable control of material through a respective nozzle;
wherein the control system is configured to control the acute angle of the wheels relative to the longitudinal axis to yield a preselected spacing between adjacent paths formed by material discharged from the nozzles.

11. The control system of claim 10, wherein the control system is further configured to selectively deactivate a subset of the nozzles on each boom extension.

12. The control system of claim 10, wherein the control system is further configured to control an angle of rotation of the boom relative to the chassis.

13. The control system of claim 12, wherein the control system comprises at least one actuator configured to cause the boom to rotate about a joint.

14. A method of adjusting effective spacing of a plurality of spray nozzles carried by a boom of a vehicle, the method comprising:
navigating the vehicle in a forward direction of travel;
dispensing a material through the plurality of spray nozzles along a plurality of paths, each path corresponding to a spray nozzle; and
orienting the boom at an acute angle relative to the forward direction such that a minimum distance between adjacent paths is less than a distance between corresponding spray nozzles along the boom.

15. The method of claim 14, further comprising selectively deactivating a subset of the nozzles on each boom extension.

16. The method of claim 15, wherein the minimum distance between adjacent paths is greater than a distance between adjacent spray nozzles along the boom.

17. The method of claim 14, wherein orienting the boom at an acute angle relative to the forward direction of travel comprises orienting the boom at an acute angle relative to a longitudinal axis of the vehicle.

18. The method of claim 14, wherein orienting the boom at an acute angle relative to the forward direction of travel comprises orienting a longitudinal axis of the vehicle at an acute angle relative to the forward direction of travel.
